(19) United States
(12) Patent Application Publication
(10) Pub. No.: US 2014/0106858 A1
(43) Pub. Date: Apr. 17, 2014

(54) Winning In A Game An Asset For Another Game

(71) Applicant: Zynga Inc., San Francisco, CA (US)

(72) Inventors: John Frederic Constable, San Francisco, CA (US); Jon-Paul Emile Dumont, San Francisco, CA (US); Michael J. Engle, Daly City, CA (US); Cor Robert Despota, San Francisco, CA (US); James Chia-Ming Liu, Foster City, CA (US); Michael Anthony Fox, San Francisco, CA (US)

(73) Assignee: Zynga Inc., San Francisco, CA (US)

(21) Appl. No.: 14/054,429

(22) Filed: Oct. 15, 2013

Related U.S. Application Data
(60) Provisional application No. 61/714,390, filed on Oct. 16, 2012.

(51) Int. Cl. A63F 13/40

(52) U.S. Cl. CPC A63F 13/10
USPC 463/25

(57) ABSTRACT

Methods, systems, and computer programs are presented for executing a computer game. One method includes an operation for detecting that a player playing in a first game also has played a second game, where the first game is different from the second game. Further, the method includes another operation for determining an asset for the second game that may be awarded for a required amount of progress made by the player in the first game. The player is notified in the first game that the player is eligible to obtain the asset while playing the first game. The asset is awarded to the player for use in the second game when the required amount of progress is made in the first game.

### CLAIM OF PRIORITY

This application claims priority from U.S. Provisional Patent Application No. 61/714,390, filed Oct. 16, 2012, and entitled “WINNING IN A GAME AN ASSET FOR ANOTHER GAME.” This provisional application is herein incorporated by reference.

### CROSS REFERENCE TO RELATED APPLICATIONS

This application is related by subject matter to U.S. patent application Ser. No. 13/483,971, filed May 30, 2012, and entitled “VIRAL PROGRESSIVE JACKPOT.”

### BACKGROUND

1. Field of the Invention

The present embodiments relate to methods for executing games in a distributed environment, and more particularly, methods, systems, and computer programs for providing rewards in several games.

2. Description of the Related Art

The online game industry has experienced dramatic growth in the last few years. One of the areas that have experienced a large growth is the area of games that promote social interactions between the players. These social interactions are sometimes referred to as viral interactions. Games where players interact with friends and other non-friends provide a more lifelike experience, because the players interact with real people instead of just with game characters.

Due to the proliferation of online games, players have many choices for playing games, which often results in players hoping from game to game, playing a game for a short amount of time before switching to another online game. Game developers have the challenge to keep players engaged in the game for longer periods in order to generate revenues that drive the development and growth of their games.

It is in this context that embodiments arise.

### SUMMARY

Methods, devices, systems, and computer programs are presented for winning assets while playing a first game, where the assets are to be used in a second game. It should be appreciated that the present embodiments can be implemented in numerous ways, such as a method, an apparatus, a system, a device, or a computer program on a computer readable medium. Several embodiments are described below.

In one embodiment, a method for executing a computer game is provided. The method includes an operation for detecting that a player playing in a first game also has played a second game, where the first game is different from the second game. Further, the method includes another operation for determining an asset for the second game that may be awarded for a required amount of progress made by the player in the first game. The player is notified in the first game that the player is eligible to obtain the asset while playing the first game. The asset is awarded to the player for use in the second game when the required amount of progress is made in the first game, where operations of the method are executed by a processor.

In another embodiment, a method for executing a computer game includes an operation for receiving a promotion by a first game, the promotion including information about an asset for a second game that may be awarded for a required amount of progress made by a player in the first game. The first game is different from the second game. The player is notified while playing the first game that the player is eligible to obtain the asset in the first game, and the asset is awarded to the player for use in the second game when the required amount of progress is made in the first game.

In yet another embodiment, a method for executing a computer game includes an operation for detecting a player playing a first game that is a gambling game. Further, the method includes another operation for determining an asset for a second game that may be awarded for a required amount of progress made by the player in the first game, where the first game is different from the second game, and the second game is not a gambling game. In the first game, the player is notified that the player is eligible to obtain the asset in the first game, and the asset is awarded to the player for use in the second game when the required amount of progress is made in the first game.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1A is a Graphical User Interface (GUI) for the lobby of a casino game, according to one embodiment.

FIG. 1B illustrates an interface for playing a game in a mobile device, according to one embodiment.

FIGS. 2A-2B illustrate embodiments for winning a foreign asset to be utilized in another game.

FIGS. 3A-3B illustrate the instructions given for winning a foreign asset, according to one embodiment.

FIGS. 4A-4B illustrate how to win the foreign asset, according to one embodiment.

FIGS. 5A-5B illustrate an interface describing the acquisition of an asset that was obtain by playing in another game, according to one embodiment.

FIG. 6A illustrates the interaction between player and server and the different types of foreign assets that may be obtained, according to one embodiment.

FIG. 6B illustrates some of the interactions between the player, the game servers, and the inter-game server, according to one embodiment.

FIG. 7A is a flowchart for winning a foreign asset, according to one embodiment.

FIG. 7B is a flowchart describing interactions with the game server for determining the foreign asset, according to one embodiment.

FIG. 7C is a flowchart for executing the computer game that allows the player win foreign assets, according to one embodiment.

FIG. 7D is a flowchart for executing a computer game, according to one embodiment.

FIG. 8 illustrates an implementation of a Massively Multiplayer Online (MMO) infrastructure, according to one embodiment.

FIG. 9 illustrates an example network environment suitable for implementing embodiments.

FIG. 10 illustrates an example computer system for implementing embodiments.

### DETAILED DESCRIPTION

The following embodiments describe a method and apparatus for executing a computer game, and more specifically methods, systems, and computer programs for playing a game that allows the player to obtain a foreign asset defined to be used in a different game. It will be apparent, that the present embodiments may be practiced without some or all of these specific details. In other instances, well known process operations have not been described in detail in order not to unnecessarily obscure the present embodiments.

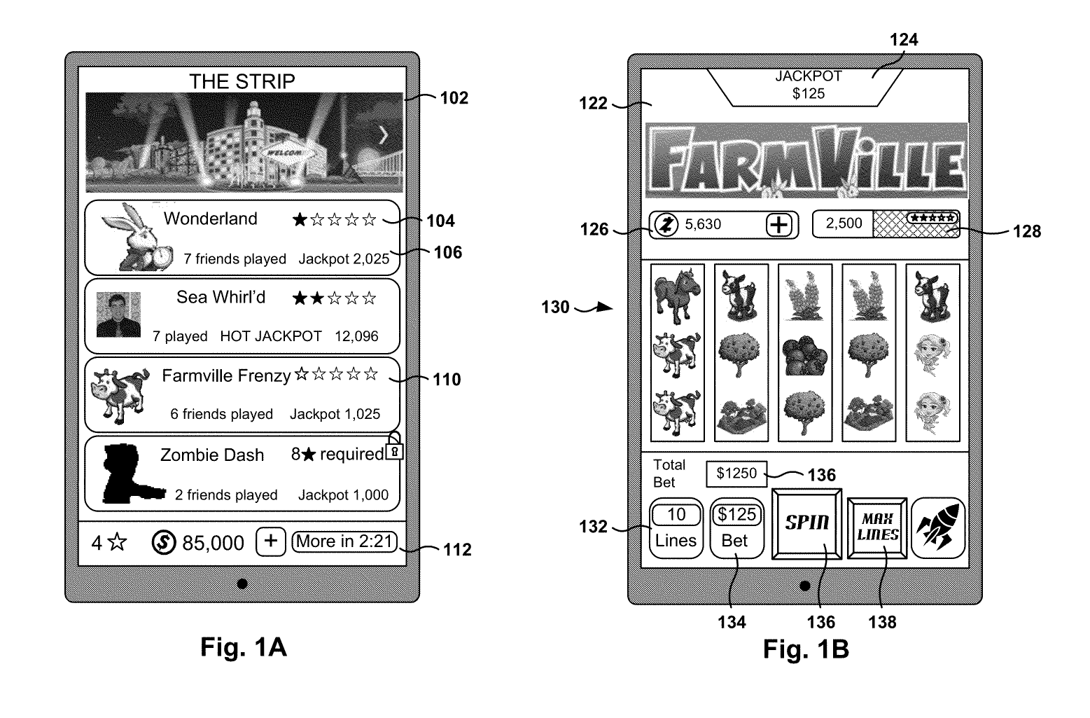

FIG. 1A is a Graphical User Interface (GUI) for the lobby of a casino game, according to one embodiment. FIG. 1A shows the interface of a slots game played on a portable device 102. The GUI represents a lobby where the player may select from one or more machines to play. Some of the machines, such as “Zombie Dash” 110 are locked and unavailable to the player because the player does not meet the requirements for playing that machine (e.g., the player has not earned enough stars to play Zombie Dash). Other machines like Wonderland 104, Sea Whirl'd, and Farmville Frenzy are open and unlocked to play. In one embodiment, the machines are referred to as theme machines because the machines are built around a theme, which includes one or more of background images, art, style, payout rates, symbols utilized in the wheels of the slots, etc. In one embodiment, as the player advances in the game, the player is given access to new theme machines that provide some advantages, such as better chances of winning, ability to win items that are not available in the lower level machines, ability to win assets for use in other games, etc.

In one embodiment, message 106 shows how many friends are playing at the particular machine or what the size of the player's jackpot is. At the bottom of the GUI, and informational area 112 indicates, among other things, how much game currency the player has (e.g., 85,000) and how many stars the player has, the stars indicating how much progress has been made in the game.

In the casino game of FIG. 1A, the player is able to win as prizes some assets that may be utilized in other games. For description purposes, as used herein, two games are different when the games are independent from each other. This means, that a player may play one game without having to play the other game, the characters or assets used in one game may not be used in the other game, there is no asset that may be used in both games, the asset for one of the games has no value nor provide any functionality in the other game, progress in one game does not affect the progress in the other game (except when the progress in one game is made to win the asset for the other game, as described herein), etc.

Further, as used herein, there is a first game and a second game which are different. The first game is the game that a player plays to obtain an asset usable in the second game. The asset is referred to as a “foreign asset” because it is not usable in the first game, which is the game that “gives” the asset to the player. On the other hand, assets that are usable in the game the player is playing are referred to as “native assets.” Therefore, an asset usable in the second game is a foreign asset when playing the first game and is a native asset when playing the second game.

The first game is referred to herein as the “giver game” or the “giving game” because it is the game where the foreign asset is given, obtained, or won. The second game is referred to herein as the “realm game,” “foreign game,” or “receiving game” because it is the game where the foreign asset may be used to make progress.

It is noted that the some of the embodiments described herein describe how a player may win prizes in a gambling game, the prizes being foreign assets to be used in other games. However, the concept of winning a foreign asset is applicable to any pair of games. Other embodiments may utilize different games, types of assets, ways of winning the foreign asset, etc. The embodiments illustrated herein should therefore not be interpreted to be exclusive or limiting, but rather exemplary or illustrative.

FIG. 1B illustrates an interface for playing a game in a mobile device, according to one embodiment. Once the player selects a theme machine, the player is presented a GUI 122 to play slots. On the top, the jackpot amount 124 is displayed. The total amount of currency to bet in the game is presented in field 126, and a progress bar 128 shows the progress made by the player in the current machine. The progress bar 128 also includes a number of stars earned in the theme machine.

The wheels 130 spin when the player presses the spin button 136. The player is able to enter the amount of lines 132 being bet on every time the wheels spin. Each of the lines includes a different combination of symbols from the wheels. For example, one line may include the five symbols across the center line, while other lines may form different combinations of symbols, such as the top symbol on the first three wheels, followed by the center symbol in the fourth wheel, and followed by the bottom symbol in the fifth wheel.

In bet field 134 the player enters the amount being bet for each line, and the total bet field 136 indicates the total amount bet in the current spin. The total bet amount is equal to the number of lines 132 times the bet per line 134. A maximum lines button 138 provides a shortcut to the player for betting the maximum number of lines.

In one embodiment, the player is able to obtain virtual goods or assets for other games instead of winning coins when spinning the wheels. In the exemplary embodiment of FIG. 1B, the player has selected a theme machine associated with another game named FarmVille, developed by the assignee of the present application.

When the user plays in the FarmVille machine, the player may win virtual coins as in any slots machine. In addition, when certain combinations come up the game gives the player assets that may be used in the FarmVille game. For example, the player may wind fertilizer for his farm, a new bull, a decoration, etc. In addition, the FarmVille machine may also provide FarmVille assets as rewards for other criteria, such as winning a certain amount of currency, spending certain amount of real cash in the slots game, playing with certain frequency, etc.

In one embodiment, when the player plays the FarmVille game, a message is displayed to notify the player of the assets obtained while playing slots. In another embodiment, the assets won may be added to the player's inventory without notification.

In another embodiment, some of the theme machines of the slots game are associated with their respective game. In these theme machines, the player may win foreign assets only for the associated games, so the player knows that by playing in a certain theme machine the player may win foreign assets for that game.

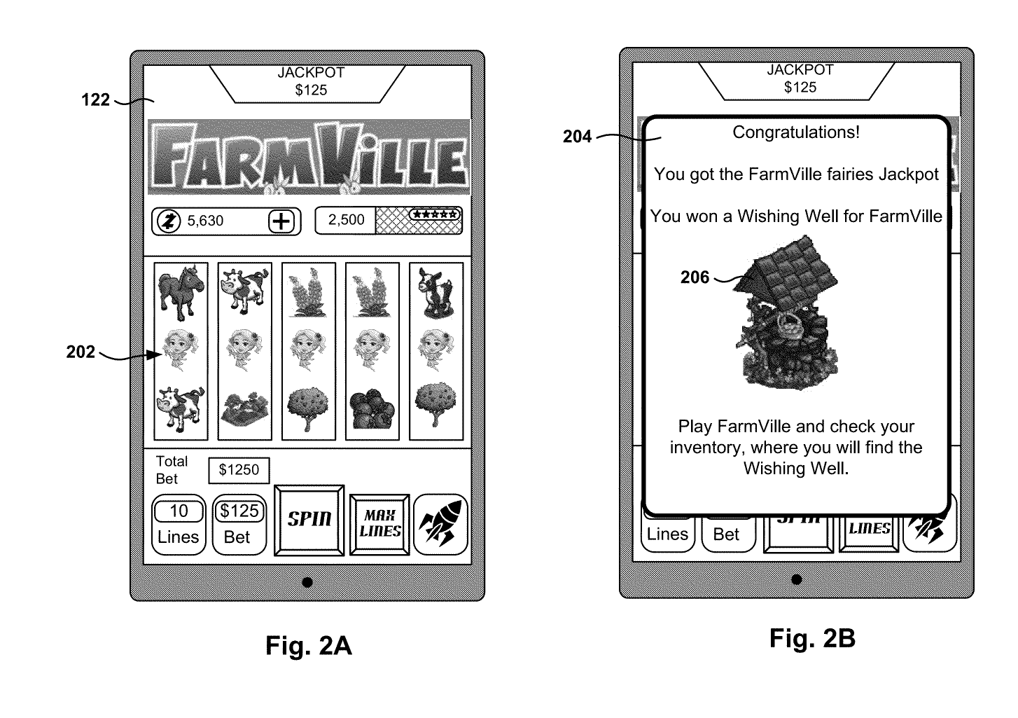

FIGS. 2A-2B illustrate embodiments for winning a foreign asset to be utilized in another game. FIG. 2A shows the slots-game GUI after the player has obtained a winning combination 202. In this exemplary winning combination 202, the player has obtained five equals symbols (a fairy) in the center line. This particular combination gives the player a foreign asset for use in FarmVille.

FIG. 2B shows the message 204 presented to the player to notify the player that the foreign asset has been acquired. In this case, the player has won a Wishing Well 206 decoration, and when the player goes back to play the FarmVille game, the Wishing Well 206 decoration may be found in the inventory of the player. The player is able to use the Wishing Well from inventory and place it in the desired location of the FarmVille board game.

In another embodiment, there may be certain foreign assets, named restricted assets, which may be available to the player only by playing slots. In other words, the restricted foreign asset can only be obtained as a foreign asset and not as a native asset for the game where it has value. Therefore, if a player wants to obtain a restricted asset for FarmVille, the player has the motivation to play slots to obtain the restricted asset.

Some games have a generic gift that may be awarded to the player for different reasons, such as for having consistency, as a promotion, as a reward, for helping friends, for inviting friends, etc. The generic gift is sometimes referred to as a mystery gift. The player does not know what the mystery gift is until the player performs an action to reveal the content of the gift, sometimes presented as a gift box.

In one embodiment, the content of the mystery gift is not determined until the time when the player opens the mystery gift. This way, the game may use logic to determine an appropriate gift for the player, given the current game situation, such as current level, expertise, energy, wish list, assets needed by the player to complete quests, etc.

In one embodiment, the giver game (e.g., the slots game) gives the player a foreign mystery gift to the player when the player obtains certain combination of the wheels. The advantage of the mystery gift is that the first game does not have to determine or reveal the identity of the foreign asset in advance. The giver game notifies the realm game that a mystery gift has been awarded to the player. The content of the foreign mystery gift is not identified until the player goes to the realm game and opens the mystery gift. The mystery gift acts as a catch-all foreign asset, which simplifies the process of identifying foreign assets for rewarding the player in giver games.

In one embodiment, to win a special kind of foreign asset, the player must play in more than two non-realm games. This type of asset is referred to as a multi-giver foreign asset, because the player must play in two or more giver games before the foreign asset is provided to the player. For example, to win a rare orchid seed for FarmVille, the player must play at least 50 spins of the wheel in the slots game, 25 hands of poker in a poker game, and build a house in a construction-type game.

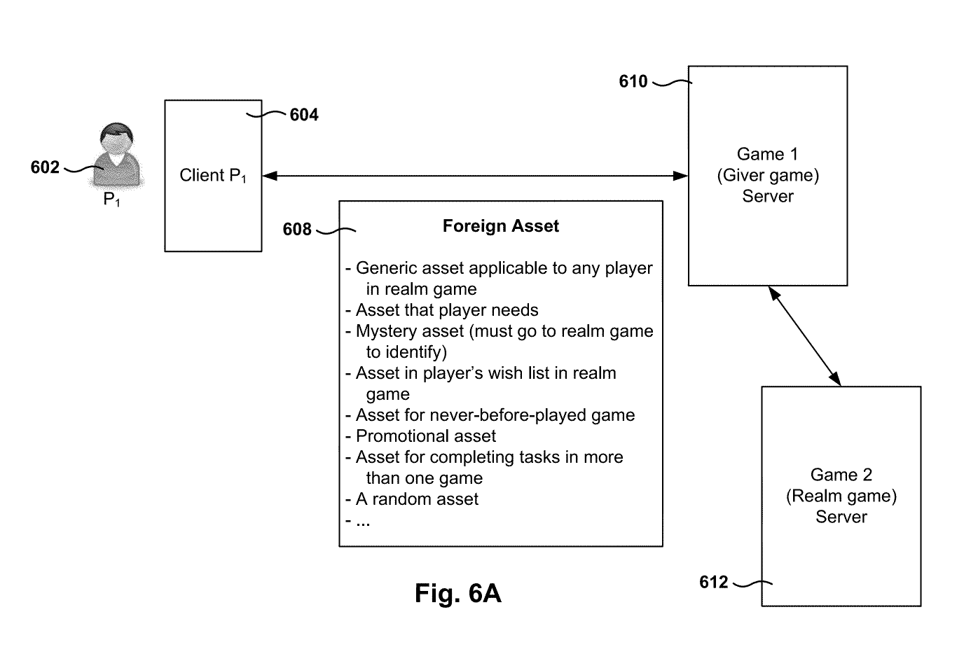

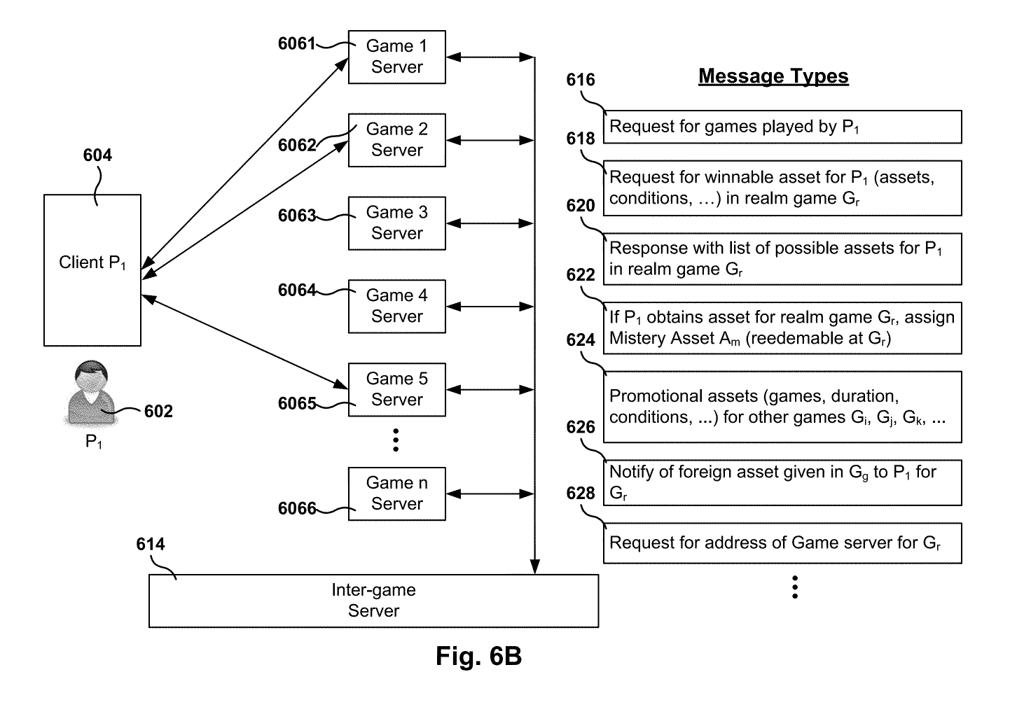

When the player has met all the conditions, the giver game where the player is playing awards the multi-giver foreign asset to the player. In order to be able to deliver these multi-giver foreign assets, coordination must be performed among the different game servers, such as by utilizing the inter-game server 614 described in more detail below with reference to FIG. 6B.

Additionally, the player may be given a foreign asset for a game that the player has never played before. This type of assets are referred to as promotional foreign assets, because they are given as promotions in order to encourage the player to play the realm game that the player has never played before.

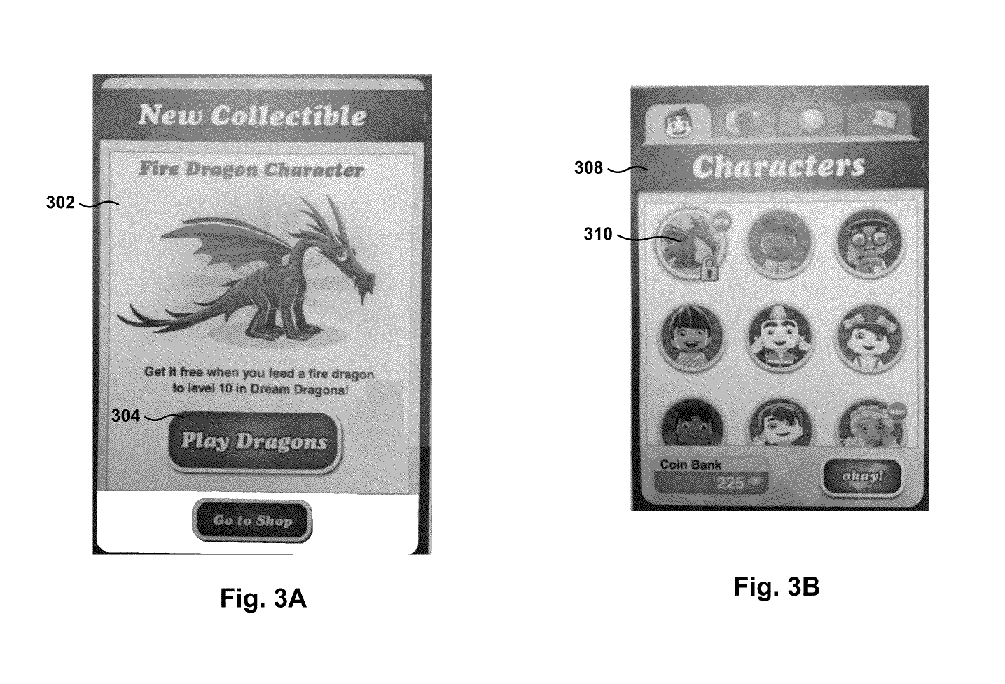

FIGS. 3A-3B illustrate the instructions given for winning a foreign asset, according to one embodiment. FIGS. 3A-3B, 4A-4B, and 5A-5B illustrate the links and interfaces between two different games, a giver game and a realm game. In this exemplary embodiment, the giver game is “Dream Dragons,” a fantasy game, and the realm game is Hanging with Friends, a social-interaction game. Both games are developed by Zynga Inc., the assignee of the present patent application.

FIG. 3A shows a screen presented while playing Hanging With Friends. A message 302 is displayed that notifies the user that a collectible item (e.g., a Fire Dragon Character) for the Hanging with Friends game may be obtained in the Dragons game. The message indicates that the collectible Dragon may be obtained when the player feeds a fire Dragon to level 10 in Dream Dragons. Button 304 is provided to take the player to the Dream Dragons game.

FIG. 3B, also from the Hanging With Friends game, displays the characters 308 that the player may use to play the game. The Fire Dragon character 310 appears with a lock symbol indicating that the character is not yet available, although the player may obtain the character by fulfilling the required conditions.

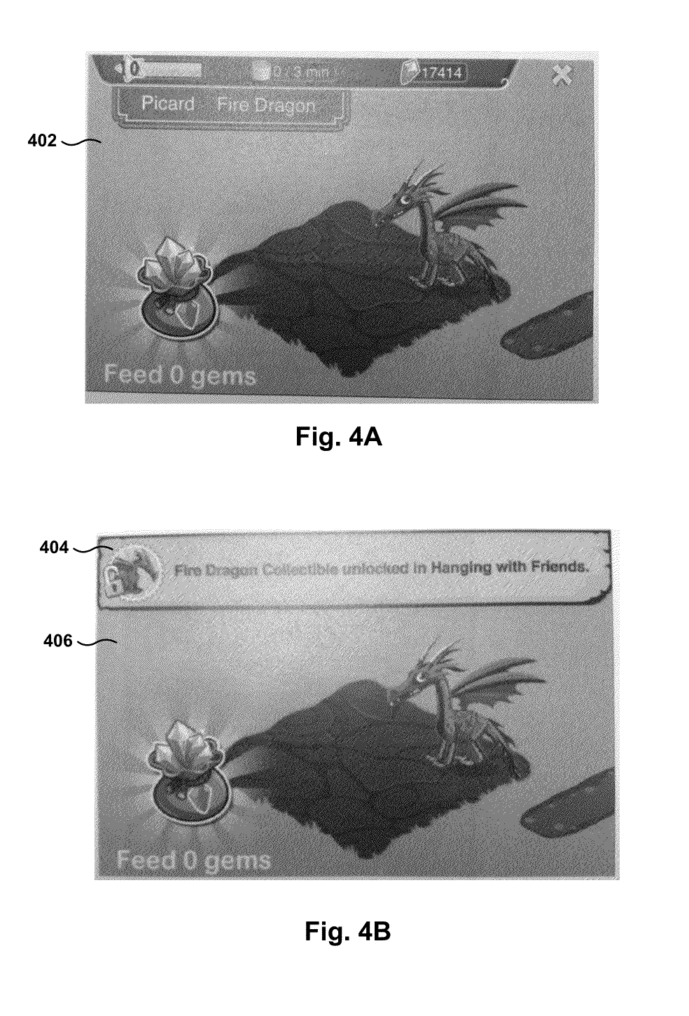

FIGS. 4A-4B illustrate how to win a foreign asset, according to one embodiment. FIGS. 4A-4B present displays obtained while playing the Dream Dragons game. FIG. 4A shows a display 402 of the Dream Dragons game, where the player has reached level 10 while playing with the Fire Dragon. The condition displayed in the Hanging With Friends game was that the player reach level 10 with the Fire Dragon, and since the player has reached the required level, then the game unlocks the Fire Dragon Collectible in the Hanging with Friends.

It is noted that in this exemplary embodiment, there is a close relationship between the native and the foreign asset, but although they are related, they are not identical and each have a different function and value. Both assets may appear the same because they are both related to a Fire Dragon. The Fire Dragon character is a native asset in the Dream Dragons game because the Fire Dragon character is used by the player to make progress in this game. However, the Fire Dragon Collectible is not a native asset in the Dream Dragons game, because this collectible may only be used in the Hanging With Friends game. The Fire Dragon Collectible is a native asset in the Hanging With Friends game.

FIG. 4B shows display 406, which includes a message 404 notifying the user that the Fire Dragon Collectible has been unlocked for use in the Hanging With Friends game.

In one embodiment, the conditions to win a foreign asset may include time-based conditions. That is, the player may have to perform some game actions in a predetermined amount of time. For example, the game may notify the user that “you may win a Fire Dragon Collectible if you play 25 hands of poker within the next three days.”

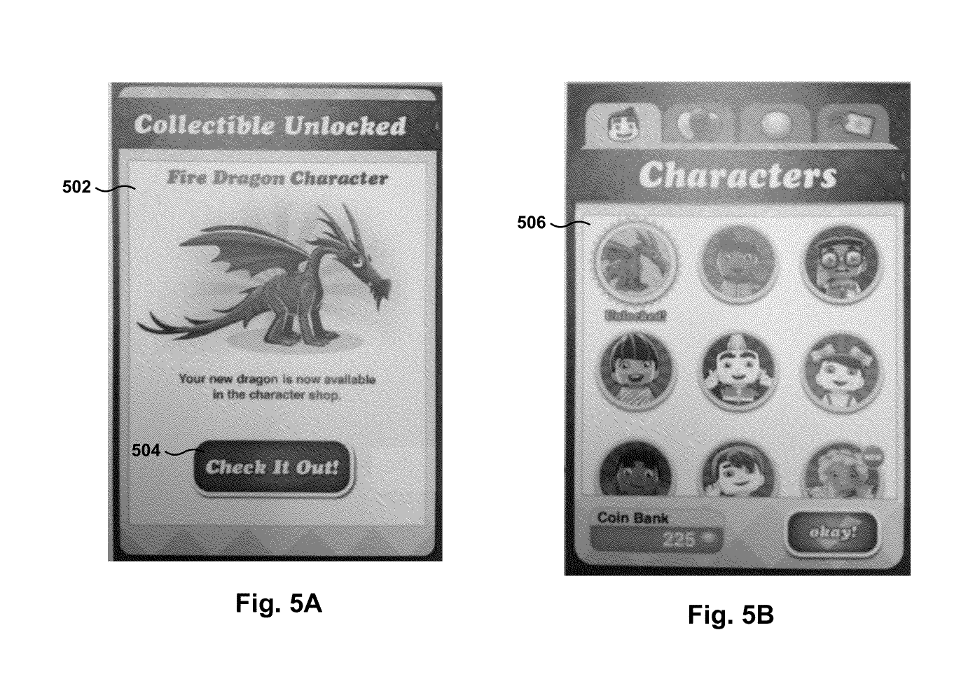

FIGS. 5A-5B illustrate an interface describing the acquisition of an asset that was obtain by playing in another game, according to one embodiment. When the player returns to the realm game (e.g., Hanging With Friends) after winning the foreign asset in the giver game (e.g., Dream Dragons game), a message 502 is displayed notifying the user that the Fire Dragon Collectible (i.e., the foreign asset won in Dream Dragons) is now available in inventory (e.g., the character shop).

A shortcut button 504 is provided to take the user to the character shop, if so desired. FIG. 5B shows the display of the character shop, similar to the one in FIG. 3B. However, the Fire Dragon collectible is now unlocked and the user may now select this character to play in the game.

It is noted that the embodiments illustrated in FIGS. 1A-5B are exemplary. Other embodiments may utilize different games, different conditions to obtain foreign assets, different types of foreign assets, different layouts, mystery gifts, etc. The embodiments illustrated should therefore not be interpreted to be exclusive or limiting, but rather exemplary or illustrative.

FIG. 6A illustrates the interaction between player and server and the different types of foreign assets that may be obtained, according to one embodiment. Player P₁ 602 is playing game 1 in client device 604 that communicates with game 1 server 610 to perform game operations. In one embodiment, game 1 server 610 interfaces with game 2 server 612 to give player P1 the ability to win foreign assets in game 1 for game 2.

The communication between the servers may include different exchanges of information, such as requesting one or more foreign assets from game 2 server 612, sending a list of foreign assets to game 1 server 610, sending and instruction to give a mystery gift as a foreign asset, etc. More details with reference to the communication exchange between servers are given below with reference to FIG. 6B.

The foreign assets that may be awarded to the player 602 may be of different types. In one embodiment, the foreign asset 608 may be one or more of the following:
A generic asset that may be of value to any player that plays the realm game (e.g., energy, expertise, ammo, seeds, etc.);
An asset that player P₁ needs to make progress in the realm game. For example, the player may have a quest in progress that requires the completion of three tasks, and the player has already completed two of the three tasks. The game could give the player an asset to complete the third task, and help the player to finish the quest (e.g., give nails to finish a table when the player already has wood and the tools required for completing the quest);
A mystery gift or mystery asset whose content is identified when the player plays game 2;
An asset in the player's wish list in game 2;
A foreign asset for a game that the player has never played before to encourage the player to play the new game;
A promotional asset that may be available for a limited time (e.g., an Olympic medal, a Super Bowl trophy, a World Series collectible, etc.);
A foreign asset obtained for completing tasks in more than one game, similar to a scavenger hunt that requires the player to perform tasks in multiple games or locations;
A random asset;
A random asset for a random game;
etc.

The foreign asset may be any asset that the user may use for progress while playing the realm game. Progress may be of many types, such as getting expertise, points, wealth (e.g., virtual currency), weapons, food, stamina, strength, tools, seeds, land, game expansions, collectibles, vehicles, buildings, fortifications, avatars, characters, keys, clues, wildcards, colors for drawing, clothes, partner, maps, treasures, free spins, access to mini-games, viral recognition, etc.

FIG. 6B illustrates some of the interactions between the player, the game servers, and the inter-game server, according to one embodiment. Player P₁ 602 plays games in client device 604 that communicates with one or more game servers 6061-6066. In the exemplary embodiment of FIG. 6B, the player has played at least once games 1, 2, and 5, with respective servers 6061, 6062, and 6065.

In one embodiment, an inter-game server 614 operates as a game broker to facilitate communications between the game servers 6061-6066. This does not mean that all communications have to go through the inter-game server 614, as the game servers may also communicate directly with other game servers.

The inter-game server provides utility services that enable the game servers to award foreign assets. For example, the inter-game-server 614 may provide one or more of the following information to the game servers: address of other game servers, games that a player has played from the games associated with the inter-game server, social links (i.e., friends) of the player in one or more games, other information associated with the player (e.g., playing habits, spending patterns, hours played per week, etc.), foreign assets that may be awarded to the player for a given realm game, possibility of awarding a mystery gift, notifying a realm game that a foreign asset has been awarded in a giver game for the realm game, etc. In general, the inter-game server 614 acts as a utility server to enable inter-game asset giving.

In one embodiment, in order to be able to award foreign assets, the game server of the giver game, referred to as the giver game server (i.e., the game that the player is presently playing), sends a request to the inter-game server for a list of the games that the player has played at least once. The inter-game server responds with a list of the games that the player has played and that accept the award of foreign assets. Of course, the list may be an empty list if the player has not played other games, or if there are no games with the ability to support foreign-asset giving.

The giver game server then contacts one of the game servers in the list (if the list is not empty) to get a list of possible foreign assets for the player. The game server for the realm game is referred to as the realm game server. When the realm game server provides the list of one or more foreign assets that can be awarded, the giver game server notifies the user (if necessary) that foreign assets may be obtained. If the player wins one of the foreign assets, then the giver game server notifies the realm game server that a foreign asset has been awarded.

In another embodiment, the request for a list of foreign assets is sent to the inter-game server 614, and the list of the one or more assets is sent from the inter-game server to the giver game server, without requiring the realm game server to be involved. To support this feature, the different game servers update the inter-game server with information regarding foreign assets and players in order to enable the inter-game server to notify the game servers of what foreign assets are available.

The communications between game servers that award foreign assets may support a plurality of protocols for information exchange. For example, in one embodiment the possibility of awarding foreign assets is hardcoded or configured in a game, without having to rely on the inter-game server for obtaining this information. In another embodiment, the game servers may send requests to other game servers to find out if the player has played the respective game, to determine if foreign-asset rewarding is possible, to determine if promotional assets for never-before-played games are possible, etc.

It is also noted, that some of these operations to facilitate foreign-asset given may also be performed in the background. For example, the inter-game server may create a database of player and game information to facilitate to asset giving. The database may include the games the player has played, the games that support foreign-asset giving, game server access information, etc. Therefore, when a giver game wants to facilitate foreign-asset giving, the giver game server access the database to obtain the required information.

Further, the notifications that a player has won foreign assets may be placed in a queue associated with the player in the realm game. When the player signs into the realm game, the realm game processes the queue in order to add the foreign assets to the inventory of the player. This way, realm game servers do not have the process the foreign assets until it is necessary. In one embodiment, the queues with foreign assets are processed periodically by the game servers.

In one embodiment, the inter-game server 614 evaluates the game-playing patterns of the player in order to determine which are the potential realm games. For example, the inter-game server may not select a certain game if the player has not played that game recently (e.g., within the last six months, although other periods of time are also possible). Further, the inter-game server 614 may give priority to the games that the player is playing more often.

FIG. 6B further includes some exemplary messages that may be exchanged between game servers 6061-6066 or between the game servers on the inter-game server 614. Message 616 is a request for the games played by a certain player P₁. A message 618 is a request for the foreign assets that may be won by player P₁ in a realm game Gᵣ. The response 620 to message 618 includes a list of the possible foreign assets for P₁ in Gᵣ, including the characteristics of the assets and, in one embodiment, conditions for awarding those assets.

Message 622 is sent from the realm game server to the giver game server, instructing the giver game server to assign a mystery asset Aₘ to the player P₁ when the player P₁ wins a foreign asset for realm game Gᵣ. Message 624 includes a list of promotional assets (indicating for what games, the duration of the promotion, the conditions for updating these promotional assets, etc.) for one or more games Gᵢ, Gⱼ, Gₖ, etc.

Message 626 notifies the realm game server that a foreign asset was given to the player P1 by the giver game. In addition, message 628 is a request for the address of game server Gᵣ.

It is noted that the embodiments illustrated in FIGS. 6A and 6B are exemplary. Other embodiments may utilize different communication protocols, combine the functionality of two or more servers into one, split the functionality of one server into a plurality of distributed servers, omit the use of the inter-game server 614, use different types of messaging for communication exchange regarding foreign-asset given, etc. The embodiments illustrated in FIGS. 6A and 6B should therefore not be interpreted to be exclusive or limiting, but rather exemplary or illustrative.

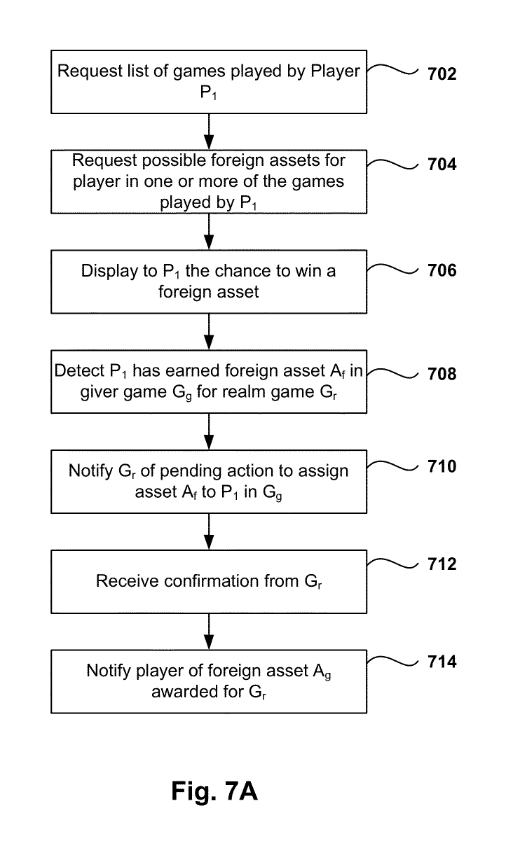

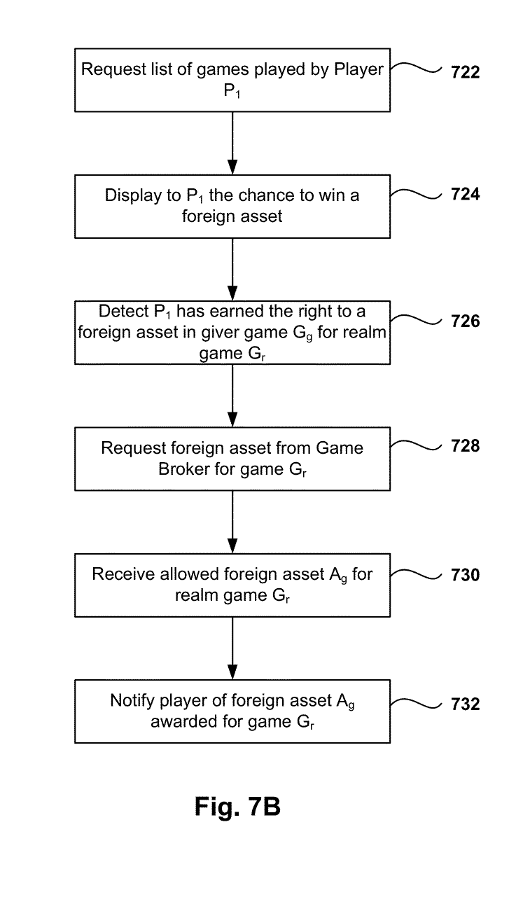

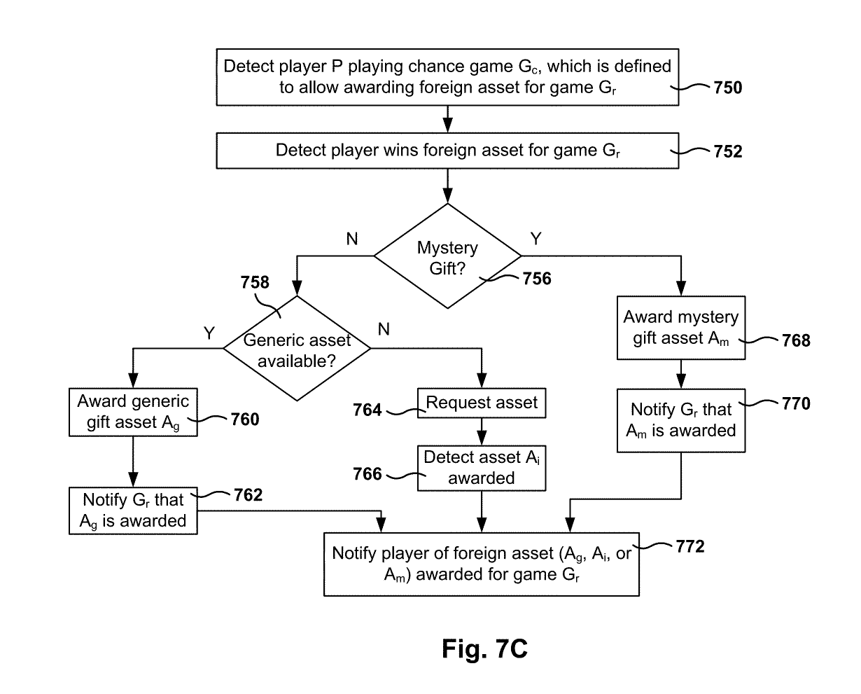

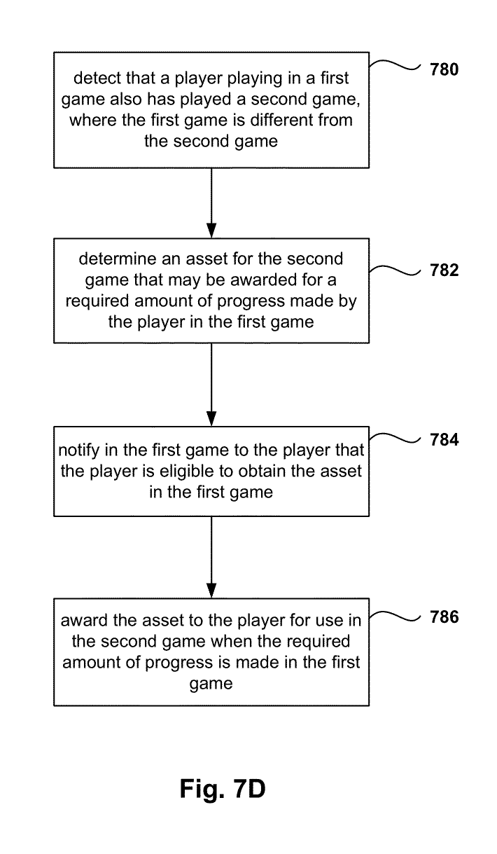

FIG. 7A is a flowchart for winning a foreign asset, according to one embodiment. In operation 702, a list of the games played by a player P1 is requested. In one embodiment, the request is sent to an inter-game server, and in another embodiment, the request is sent directly to one or more realm game servers.

From operation 702, the method flows to operation 704 where a request is sent from the giver game to the realm game requesting a list of one or more possible foreign assets that the player may win in the giver game. After receiving the list of foreign assets, in operation 706, the giver game displays to player P₁ that it is possible to win a foreign asset for the realm game.

From operation 706, the method flows to operation 708 where the game detects that player P₁ has earned a foreign asset A_{f} in the giver game for the realm game Gᵣ. For example, the player has met all the conditions to win the foreign asset, or the player has obtained a winning combination in the spin of the wheels in the slots game (see for example FIG. 2A), etc.

In operation 710, the giver game G_{g} notifies the realm game Gᵣ that the giver game G_{g} is ready to give a foreign asset A_{f} to player P₁. After the giver game receives confirmation, in operation 712, from the realm game Gᵣ that the foreign asset may be awarded, the giver game Gᵣ notifies, in operation 714, the player that the foreign asset A_{g} has been awarded for use in realm game Gᵣ.

In another embodiment, the giver game does not require confirmation from the realm game to award the foreignasset, and operations 710 in 712 are omitted. In this case, the giver game sends a message to the realm game to inform that the player has earned the foreign asset.

FIG. 7B is a flowchart describing interactions with the game server for determining the foreign asset, according to one embodiment. In operation 722, the giver game requests a list of the games played by player P₁. From operation 722, the method flows to operation 724 where the giver game displays to the player the chance to win a foreign asset.

From operation 724, the method flows to operation 726 where the game detects that the player has earned the right to obtain a foreign asset for the realm game. From operation 728 the method flows to operation 730. The giver game receives a confirmation that the giver game is allowed to give a foreign asset A_{g} for the realm game Gᵣ. In operation 732, the giver game notifies the player that the player has won the foreign asset A_{g} to be used in realm game Gᵣ.

FIG. 7C is a flowchart for executing the computer game that allows the player win foreign assets, according to one embodiment. In operation 750, the game detects that the player is playing in a chance game G_{c}, that is defined to allow the giving of foreign assets to the player for a realm game Gᵣ. In operation 750, the method flows to operation 752 where the giver game G_{c} detects that the player has won a foreign asset for realm game Gᵣ.

In operation 756, a check is performed to determine if the asset won in operation 752 is a mystery gift. If the asset is a mystery gift the method flows to operation 768, and if the asset is not a mystery gift the method flows to operation 758.

In operation 758 a check is performed to determine if a generic asset is available for awarding the generic asset to the player. If the generic asset is available, the method flows to operation 760, and if the generic asset is not available the method flows to operation 764. In operation 760, a generic foreign gift asset A_{g} is awarded to the player, and in operation 762, the giver game G_{c} notifies the realm game Gᵣ that the player has been awarded A_{g}.

In operation 764 (performed when the generic asset is not available), the giver game G_{c} requests and asset that may be given to the player. In one embodiment, the asset is requested from a realm game server, and in another embodiment the request is sent to an inter-game broker server, although other possibilities are also possible for determining the award. In operation 766 the asset Aᵢ is awarded to the player.

In operation 768 (performed when a mystery gift is available), the mystery gift Aₘ is awarded to the player. From operation 768, the method flows to operation 770, where the giver game G_{c} notifies the realm game Gᵣ that the player has been awarded Aₘ.

From operations 762, 766, and 770, the method flows to operation 772. The player is notified that a foreign asset has been awarded (A_{g}, Aᵢ or Aₘ) for realm game Gᵣ.

FIG. 7D is a flowchart for executing a computer game, according to one embodiment. In operation 780, the game detects that a player playing a first game has also played a second game, where the first game is different from the second game. From operation 780, the method flows to operation 782 where a foreign asset is determined for the second game. The foreign asset may be awarded in the first game for a required amount of progress made by the player in the first game.

From operation 782, the method flows to operation 784 where the player is notified in the first game that the player is eligible to obtain the foreign asset while playing in the first game. In operation 786, the asset is awarded to the player when the required amount of progress is made in the first game. The foreign asset may be used in the second game.

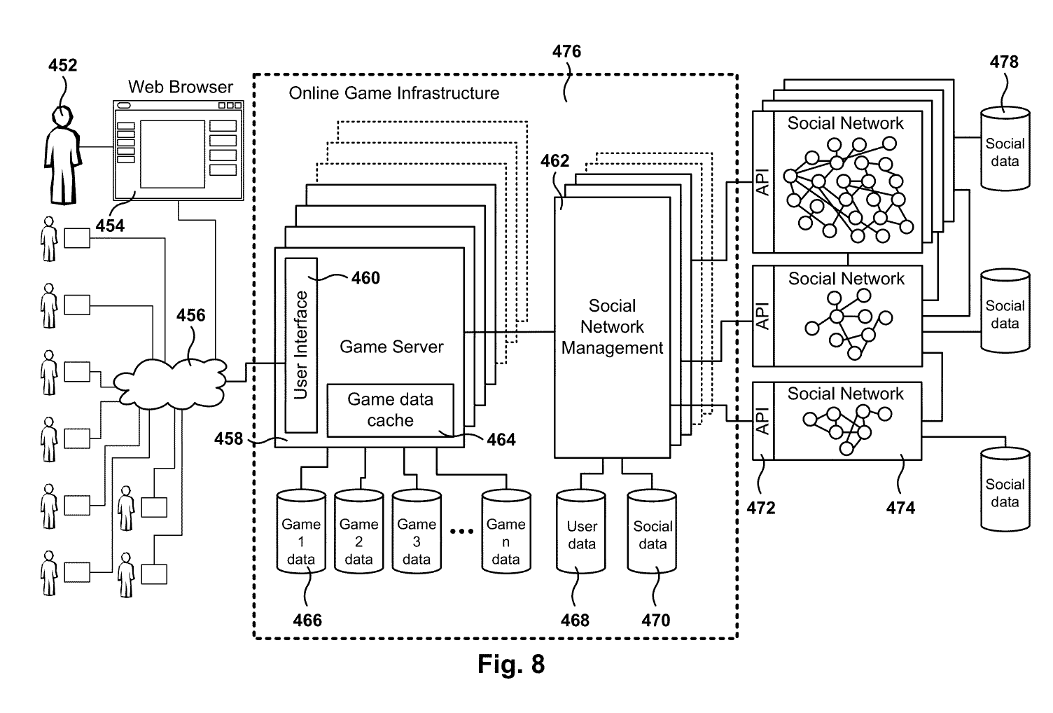

FIG. 8 illustrates an implementation of an online game infrastructure, according to one embodiment. The online game infrastructure 476 includes one or more game servers 458, web servers (not shown), one or more social network management servers 462, and databases to store game related information. In one embodiment, game server 458 provides a user interface 460 for players 452 to play the online game. In one embodiment, game server 458 includes a Web server for players 452 to access the game via web browser 454, but the Web server may also be hosted in a server different from game server 458. Network 456 interconnects players 452 with the one or more game servers 458.

Each game server 458 has access to one or more game databases 466 for keeping game data. In addition, a single database can store game data for one or more online games. Each game server 458 may also include one or more levels of caching. Game data cache 464 is a game data cache for the game data stored in game databases 466. For increased performance, caching may be performed in several levels of caching. For instance, data more frequently used is stored in a high priority cache, while data requiring less access during a session will be cached and updated less frequently.

The number of game servers 458 changes over time, as the gaming platform is an extensible platform that changes the number of game servers according to the load on the gaming infrastructure. As a result, the number of game servers will be higher during peak playing times, and the number of game servers will be lower during off-peak hours. In one embodiment, the increase or decrease of bandwidth is executed automatically, based on current line usage or based on historical data.

One or more social network management servers 462 provide support for the social features incorporated into the online games. The social network management servers 462 access social data 478 from one or more social networks 474 via Application Programming Interfaces (API) 472 made available by the social network providers. An example of a social network is Facebook, but it is possible to have other embodiments implemented in other social networks. Each social network 474 includes social data 478, and this social data 478, or a fraction of the social data, is made available via API 472. As in the case of the game servers, the number of social network management servers 462 that are active at a point in time changes according to the load on the infrastructure. As the demand for social data increases, the number of social network management servers 462 increases. Social network management servers 462 cache user data in database 468, and social data in database 470. The social data may include the social networks where a player is present, the social relationships for the player, the frequency of interaction of the player with the social network and with other players, etc. Additionally, the user data kept in database 468 may include the player's name, demographics, e-mail, games played, frequency of access to the game infrastructure, etc.

It is noted that the embodiment illustrated in FIG. 8 is an exemplary online gaming infrastructure. Other embodiments may utilize different types of servers, databases, APIs, etc., and the functionality of several servers can be provided by a single server, or the functionality can be spread across a plurality of distributed servers. The embodiment illustrated in FIG. 8 should therefore not be interpreted to be exclusive or limiting, but rather exemplary or illustrative.

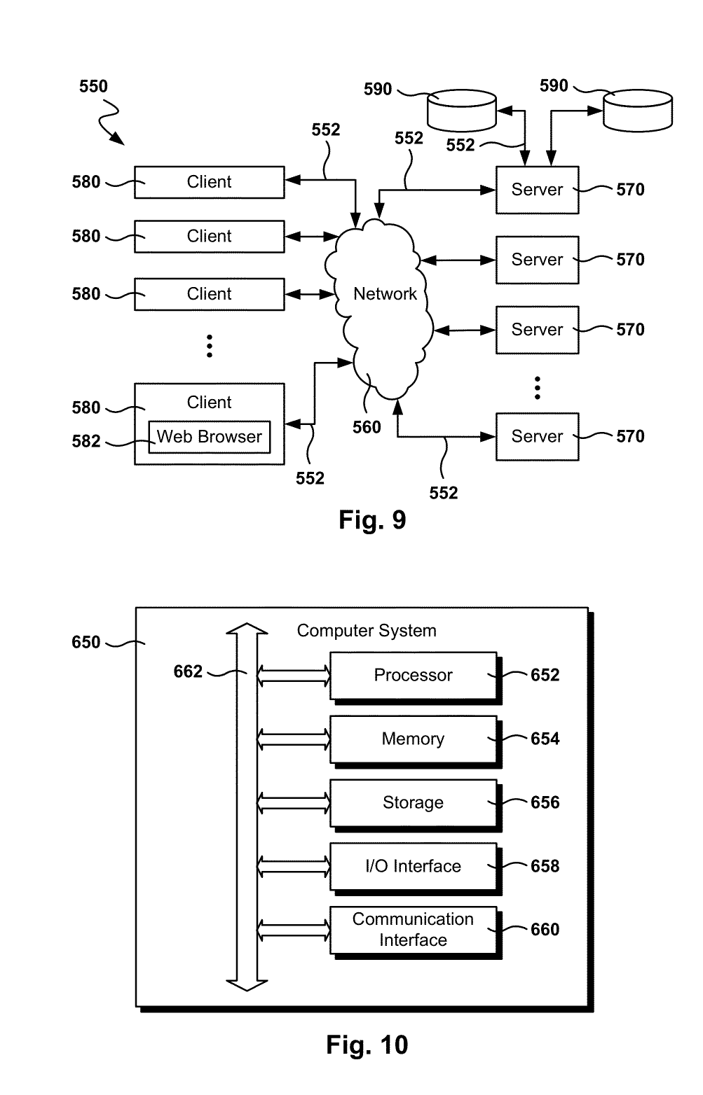

FIG. 9 illustrates an example network environment 550 suitable for implementing embodiments. Network environment 550 includes a network 560 coupling one or more servers 570 and one or more clients 580 to each other. In particular embodiments, network 560 is an intranet, an extranet, a virtual private network (VPN), a local area network (LAN), a wireless LAN (WLAN), a wide area network (WAN), a metropolitan area network (MAN), a portion of the Internet, another network, or a combination of two or more such networks 560.

One or more links 552 couple a server 570 or a client 580 to network 560. In particular embodiments, one or more links 552 each includes one or more wired, wireless, or optical links 552. In particular embodiments, one or more links 552 each includes an intranet, an extranet, a VPN, a LAN, a WLAN, a WAN, a MAN, a portion of the Internet, or another link 552 or a combination of two or more such links 552.

Each server 570 may be a stand-alone server or may be a distributed server spanning multiple computers or multiple datacenters. Servers 570 may be of various types, such as, for example and without limitation, jackpot server, web server, news server, mail server, message server, advertising server, file server, application server, exchange server, database server, or proxy server. Each server 570 may include hardware, software, embedded logic components, or a combination of two or more such components for carrying out the appropriate functionalities implemented or supported by server 570. For example, a web server is generally capable of hosting websites containing web pages or particular elements of web pages. More specifically, a web server may host HyperText Markup Language (HTML) files or other file types, or may dynamically create or constitute files upon a request, and communicate them to clients 580 in response to Hypertext Transfer Protocol (HTTP) or other requests from clients 580. A mail server is generally capable of providing electronic mail services to various clients 580. A database server is generally capable of providing an interface for managing data stored in one or more data stores.

In particular embodiments, one or more data storages 590 may be communicatively linked to one or more severs 570 via one or more links 552. Data storages 590 may be used to store various types of information. The information stored in data storages 590 may be organized according to specific data structures. In particular embodiments, each data storage 590 may be a relational database. Particular embodiments may provide interfaces that enable servers 570 or clients 580 to manage, e.g., retrieve, modify, add, or delete, the information stored in data storage 590.

In particular embodiments, each client 580 may be an electronic device including hardware, software, or embedded logic components or a combination of two or more such components and capable of carrying out the appropriate functionalities implemented or supported by client 580. For example and without limitation, a client 580 may be a desktop computer system, a notebook computer system, a notebook computer system, a handheld electronic device, or a mobile telephone. A client 580 may enable a network player at client 580 to access network 580. A client 580 may enable its player to communicate with other players at other clients 580. Further, each client 580 may be a computing device, such as a desktop computer or a work station, or a mobile device, such as a notebook computer, a network computer, or a smart telephone.

In particular embodiments, a client 580 may have a web browser 582, such as Microsoft Internet Explorer, Google Chrome, Or Mozilla Firefox, and may have one or more add-ons, plug-ins, or other extensions. A player at client 580 may enter a Uniform Resource Locator (URL) or other address directing the web browser 582 to a server 570, and the web browser 582 may generate a Hyper Text Transfer Protocol (HTTP) request and communicate the HTTP request to server 570. Server 570 may accept the HTTP request and communicate to client 580 one or more Hyper Text Markup Language (HTML) files responsive to the HTTP request. Client 580 may render a web page based on the HTML files from server 570 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in Javascript, Java, Microsoft Silverlight, combinations of markup language and scripts such as AJAX (Asynchronous Javascript and XML), and the like. Herein, reference to a web page encompasses one or more corresponding web page files (which a browser may use to render the web page) and vice versa, where appropriate.

Web browser 582 may be adapted for the type of client 580 where the web browser executes. For example, a web browser residing on a desktop computer may differ (e.g., in functionalities) from a web browser residing on a mobile device. A user of a social networking system may access the website via web browser 582.

FIG. 10 illustrates an example computer system 650 for implementing embodiments. In particular embodiments, software running on one or more computer systems 650 performs one or more operations of one or more methods described or illustrated herein or provides functionality described or illustrated herein. Although methods for implementing embodiments were described with a particular sequence of operations, it is noted that the method operations may be performed in different order, or the timing for the execution of operations may be adjusted, or the operations may be performed in a distributed system by several entities, as long as the processing of the operations are performed in the desired way.

As example and not by way of limitation, computer system 650 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 650 may include one or more computer systems 650; be stand-alone or distributed; span multiple locations; span multiple machines; or reside in a cloud, which may include one or more cloud components in one or more networks. The one or more computer systems 650 may perform in real time or in batch mode one or more operations of one or more methods described or illustrated herein.

In particular embodiments, computer system 650 includes a processor 652, memory 654, storage 656, an input/output (I/O) interface 658, a communication interface 660, and a bus 662. Although this disclosure describes and illustrates a particular computer system having a particular number of particular components in a particular arrangement, embodiments may be implemented with any suitable computer system having any suitable number of any suitable components in any suitable arrangement.

In particular embodiments, processor 652 includes hardware for executing instructions, such as those making up a computer program. As an example and not by way of limitation, to execute instructions, processor 652 may retrieve (or fetch) the instructions from an internal register, an internal cache, memory 654, or storage 656; decode and execute them; and then write one or more results to an internal register, an internal cache, memory 654, or storage 656. The present disclosure contemplates processor 652 including any suitable number of any suitable internal registers, where appropriate. Where appropriate, processor 652 may include one or more arithmetic logic units (ALUs); be a multi-core processor; or include one or more processors 652. Although this disclosure describes and illustrates a particular processor, this disclosure contemplates any suitable processor.

In particular embodiments, memory 654 includes main memory for storing instructions for processor 652 to execute, or data that can be manipulated by processor 652. As an example and not by way of limitation, computer system 650 may load instructions from storage 656 or another source (such as, for example, another computer system 650) to memory 654. Processor 652 may then load the instructions from memory 654 to an internal register or internal cache. During or after execution of the instructions, processor 652 may write one or more results (which may be intermediate or final results) to the internal register or internal cache. Processor 652 may then write one or more of those results to memory 654. One or more memory buses (which may each include an address bus and a data bus) may couple processor 652 to memory 654. Bus 662 may include one or more memory buses, as described below. One or more memory management units (MMUs) reside between processor 652 and memory 654 and facilitate accesses to memory 654 requested by processor 652. Memory 654 includes random access memory (RAM).

As an example and not by way of limitation, storage 656 may include a Hard Disk Drive (HDD), a floppy disk drive, flash memory, an optical disc, a magneto-optical disc, magnetic tape, or a Universal Serial Bus (USB) drive or a combination of two or more of these. Storage 656 may include removable or non-removable (or fixed) media, where appropriate. In particular embodiments, storage 656 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface 658 includes hardware, software, or both providing one or more interfaces for communication between computer system 650 and one or more I/O devices. One or more of these I/O devices may enable communication between a person and computer system 650. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

Communication interface 660 includes hardware, software, or both providing one or more interfaces for communication between computer system 650 and one or more other computer systems 650 on one or more networks. As an example and not by way of limitation, communication interface 660 may include a network interface controller (NIC) or network adapter for communicating with an Ethernet or other wire-based network or a wireless NIC (WNIC) or wireless adapter for communicating with a wireless network, such as a WI-FI network. As an example, computer system 650 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In particular embodiments, bus 662 includes hardware, software, or both coupling components of computer system 650 to each other. As an example and not by way of limitation, bus 662 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 662 may include one or more buses 662, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure that may store a computer program or data. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a Secure Digital card, a Secure Digital drive, or another suitable computer-readable storage medium or a combination of two or more of these, where appropriate. Herein, reference to a computer-readable storage medium excludes any medium that is not eligible for patent protection under 35 U.S.C. §101.

One or more embodiments can also be fabricated as computer readable code on a non-transitory computer readable medium. Herein, reference to software may encompass one or more applications, bytecode, one or more computer programs, one or more executables, one or more instructions, logic, machine code, one or more scripts, or source code, and vice versa, where appropriate.

The present disclosure encompasses all changes, substitutions, variations, alterations, and modifications to the example embodiments herein that a person having ordinary skill in the art would comprehend.

What is claimed is:

1. A computer implemented method for executing a computer game, the method comprising:
detecting that a player playing in a first game also has played a second game, wherein the first game is different from the second game;
determining an asset for the second game that may be awarded for a required amount of progress made by the player in the first game;
notifying in the first game to the player that the player is eligible to obtain the asset in the first game; and
awarding the asset to the player for use in the second game when the required amount of progress is made in the first game, wherein operations of the method are executed by a processor.

2. The method as recited in claim 1, wherein the detecting further includes:
sending a request to a game broker for information on games that the player has played; and
receiving a list of one or more games that the player has played.

3. The method as recited in claim 1, wherein the detecting further includes:
accessing a database with information on games that the player has played.

4. The method as recited in claim 1, wherein determining an asset further includes:
sending a request to a game server of the second game for assets to be awarded in the first game; and
receiving a list of one or more assets from the game server of the second game.

5. The method as recited in claim 1, wherein determining an asset further includes:
sending a request to a game broker for assets to be awarded in the first game; and
receiving a list of one or more assets from the game broker.

6. The method as recited in claim 1, wherein determining an asset further includes:
selecting a mystery asset, wherein the mystery asset is revealed to the player when the player plays the second game.

7. The method as recited in claim 1, wherein the asset has no value or provide any functionality in the first game and the asset has value in the second game.

8. The method as recited in claim 1, wherein the asset is one of a random asset, a generic asset, or an asset that the player needs in the second game.

9. The method as recited in claim 1, wherein the asset is one of a mystery gift, an asset in the player's wish list, or a promotional asset.

10. The method as recited in claim 1, wherein operations of the method are performed by a computer program when executed by one or more processors, the computer program being embedded in a non-transitory computer-readable storage medium.

11. A computer implemented method for executing a computer game, the method comprising:
receiving a promotion by a first game, the promotion including information about an asset for a second game that may be awarded for a required amount of progress made by a player in the first game, wherein the first game is different from the second game; notifying in the first game to the player that the player is eligible to obtain the asset in the first game; and
awarding the asset to the player for use in the second game when the required amount of progress is made in the first game, wherein operations of the method are executed by a processor.

12. The method as recited in claim 11, wherein the asset is one of energy, stamina, virtual currency, experience points, a decoration, a vehicle, a weapon, a building, an avatar, or a collectible.

13. The method as recited in claim 11, wherein the player has never played the second game before, and the asset is awarded to promote the second game.

14. The method as recited in claim 11, wherein awarding the asset further includes:
detecting that the player has made required progress in more than one different games.

15. The method as recited in claim 11, wherein the asset has no value or provide any functionality in the first game and the asset has value in the second game.

16. A computer implemented method for executing a computer game, the method comprising:
detecting a player playing a first game that is a gambling game;
determining an asset for a second game that may be awarded for a required amount of progress made by the player in the first game, wherein the first game is different from the second game, wherein the second game is not a gambling game;
notifying in the first game to the player that the player is eligible to obtain the asset in the first game; and
awarding the asset to the player for use in the second game when the required amount of progress is made in the first game, wherein operations of the method are executed by a processor.

17. The method as recited in claim 16, wherein the gambling game includes a gambling area with a theme associated with the second game.

18. The method as recited in claim 17, wherein at least one asset for the second game won in the gambling area may only be acquired in the first game.

19. The method as recited in claim 16, wherein the asset is one of a random asset, a generic asset, an asset that the player needs in the second game, a mystery gift, an asset in the player's wish list, or a promotional asset.

20. The method as recited in claim 16, wherein operations of the method are performed by a computer program when executed by one or more processors, the computer program being embedded in a non-transitory computer-readable storage medium.
